(19) United States
(12) Patent Application Publication
(10) Pub. No.: US 2004/0202468 A1
(43) Pub. Date: Oct. 14, 2004

(54) Lightpath exerciser for optical networks

(76) Inventor: Gordon Harney, Ottawa (CA)

Correspondence Address: HARNESS, DICKEY & PIERCE, P.L.C., P.O. BOX 828, BLOOMFIELD HILLS, MI, 48303, US

(21) Appl. No.: 10/413,030

(22) Filed: Apr. 14, 2003

(51) Int. Cl. H04B 10/08

(52) U.S. Cl. 398/16

(57) ABSTRACT

A lightpath exerciser is provided for testing unlit lightpaths in an optical transport network. The lightpath exerciser includes: a network resource data store for storing network topology data and network configuration data for the optical transport network, where the network configuration data includes assigned lightpath data for the optical transport network; a lightpath determination module adapted to access the network resource data store and operable to determine potential test lightpaths based on the network topology data and the network configuration data, where at least one potential test lightpath is an unlit lightpath in the optical transport network; and a test manager operable to initiate a test operation in relation to the at least one potential test lightpath. The use of the lightpath exerciser will result in lower operating costs due to improved diagnostic and preventative maintenance processes, faster service delivery by reducing delays in setting up and testing connections as well as to promoting a higher level of service availability due to a reduction in downtime resulting from protection or restoration switching.

### FIELD OF THE INVENTION

The present invention relates generally to testing and verification of unassigned and/or unlit optical channels and lightpaths in optical transport networks and, more particularly, to automated exercising of unassigned and/or unlit optical channels and lightpaths using pre-deployed transponders or special test equipment at switching nodes within a dense wavelength division multiplexing (bWDM) optical transport network.

### BACKGROUND OF THE INVENTION

Early DWDM optical transport networks typically employed point-to-point DWDM that terminated all wavelengths at a transponder into an electrical layer and then adapted the optical channel signal back to one or more client optical signals. This process is typically referred to as an OEO conversion. Client layer channel or sub-channel manual connection or switching, or packet switching is then performed in the electrical domain at an edge node to route the client signal back into the optical transport network or to route it to a client layer network. In these types of networks, an optical channel only spanned one optical channel link. The fiber and selected optical channels were tested during the installation and commissioning phases. During normal operation, the optical channel connectivity between a transponder pair does not change. As such, the lit optical channels traverse a permanently fixed route while the unlit optical channels remained unassigned and untested until extra capacity is needed which then resulted in repeating the installation and test cycles. Manual connection or switching in the optical domain was generally not supported.

More recently, next generation DWDM optical networks have been developed to minimize OEO conversions at switching nodes in order to reduce costs as well as to take advantage of the pre-deployed and scalable nature of all-optical networks. With the introduction of all-optical manual connection or switching, transparent optical multiplexing, tunable components and the drive to further reduce costs, transponders, regenerators and wave translators are now capable of being manually connected or switched within the optical domain to any wavelength in any fiber in any direction leaving the node. In these types of networks, for example as specified in ITU-T G.872, an optical channel path is formed by one or more serially concatenated optical channel links, optical channel cross-connections or manual connections and a pair of termination points. The optical channel defined herein is equivalent to the optical channel and optical channel transport unit layers defined in ITU-T G.872 and G.709.

An optical channel path is typically supported by a single wavelength at the physical layer and is terminated when the wavelength is converted from the optical domain to the electrical domain (typically at a transponder). An optical channel path may be established between any transponder pair using all-optical switches or manual connections at the end-points and midpoints to route the optical channel. Optical channel cross-connections and manual connections are performed in the optical domain. An optical channel link is a transport entity that exists between connection points and is unassigned until it is cross-connected or manually connected to another link or termination point to support an optical channel path. An optical channel link is supported by an optical multiplex section path. The optical multiplex section path consists of one or more wavelengths and is terminated when the wavelengths are demultiplexed.

A lightpath is formed by one or more serially concatenated lightpath links and lightpath cross-connections or manual connections. An optical channel path supports a lightpath link. A lightpath cross-connection or manual connection is performed in the electrical or optical domains. At a mid-point network-switching node, a lightpath may be dynamically switched to any output fiber either all-optically or through a wavelength translator or regenerator as needed to establish an end-to-end service having a specified level of quality. An optical channel path is terminated at a wavelength translator or regenerator while the lightpath is not.

In order to speed up service delivery, simplify optical channel routing, support optical layer protection and restoration, and promote optical bandwidth sharing and balancing, unassigned and/or unlit optical channel links are expected to be put into service with minimal delay. The deployment of all optical switches, together with the pre-deployed transponders at the end-points, with pre-deployed wavelength translators and regenerators at the mid-points is a significant change in the optical transport network architecture that will substantially accelerate the process of setting up new network connections or re-arranging existing network connections. The time required setting up an error-free optical channel path or lightpath directly impacts the network operator's ability to maximize revenues, reduce operations costs and provide client transport and switching services with high availability. Optical channel paths and lightpaths are typically established using a traditional network management system or an autonomous control plane system or both. Establishing fixed connections and equipment deployments will continue to be manual processes.

An optical channel link is unlit when there is no optical signal present at the specified wavelength frequency. Unassigned or assigned and shared optical channel links are typically unlit, consequently, their performance cannot be measured. Therefore, it is desirable to provide an automated means to continuously test and verify the performance all unlit optical channel links, transponders and wavelength translators/regenerators within a DWDM optical transport network prior to a new service request, route change or restoration/protection action. A lightpath exerciser will provide a high level of confidence that the performance of an optical channel will be acceptable before an end-to-end client signal connection is actually made through the optical transport network. In addition to the value of reducing turn up time and increasing service availability, the exerciser exploits the value of the pre-deployed equipment by utilizing functionality that would otherwise be dormant.

In next generation DWDM optical transport networks, network-switching nodes will be capable of routing optical channels, in the optical domain, from any input fiber to any output fiber as well as from any input or output fiber to any add/drop port. In addition, using wavelength translation and regeneration equipment, the switch will be able to route a lightpath or optical channel from any input port wavelength to any output port wavelength as well as providing signal regeneration and wavelength translation. Prior to switching an optical channel, in the optical domain, it is typically unlit and the performance is unknown. Consequently, there is an uncertainty associated with the quality of the new optical channel path or lightpath and a soaking period is typically required to collect sufficient data to verify and validate its performance once the network connection has been made. This uncertainty and soak period leads to slower service delivery and protection/restoration times. In an effort to reduce delays in service delivery and activating restoration/protection, all-optical switches will be used at network-switching nodes together with pre-deployed transponders at the edge of the optical transport network and pre-deployed wavelength translators/regenerators in the core of the network as an effective means to achieve a reduction in turn up time and improvements in service availability. Since this equipment is essentially dormant until a new service is requested or until an optical channel or lightpath is re-routed, they may be used to test the unlit optical channel links within the optical transport network until there is a need to put them in-service.

Therefore, it is desirable to provide an automated lightpath exerciser for testing unlit lightpaths in an optical transport network.

### SUMMARY OF INVENTION

In accordance with the present invention, a lightpath exerciser is provided for testing unlit lightpaths in an optical transport network. The lightpath exerciser includes: a network resource data store for storing network topology data and network configuration data for the optical transport network, where the network configuration data includes assigned lightpath data for the optical transport network; a lightpath determination module adapted to access the network resource data store and operable to determine potential test lightpaths based on the network topology data and the network configuration data, where at least one potential test lightpath is an unlit lightpath in the optical transport network; and a test manager operable to initiate a test operation in relation to the at least one potential test lightpath.

For a more complete understanding of the invention, its objects and advantages, reference may be had to the following specification and to the accompanying drawings.

### BRIEF DESCRIPTION OF THE DRAWINGS

FIG. 1 is a diagram depicting an exemplary optical transport network segment;

FIG. 2 is a diagram depicting an exemplary optical transport network segment that further identifies the managed transport entities;

FIGS. 3 and 4 are diagrams depicting an exemplary linear network segment and an exemplary mesh network segment, respectively;

FIG. 5 is a diagram depicting the primary components of a lightpath exerciser in accordance with the present invention;

FIG. 6 is a flowchart illustrating an exemplary method for determining potential test lightpaths in accordance with the present invention;

FIGS. 7A-7C are diagrams depicting exemplary linear network under test in accordance with the present invention; and

FIG. 8 is a diagram depicting an exemplary mesh network under test in accordance with the present invention.

### DETAILED DESCRIPTION OF THE PREFERRED EMBODIMENTS

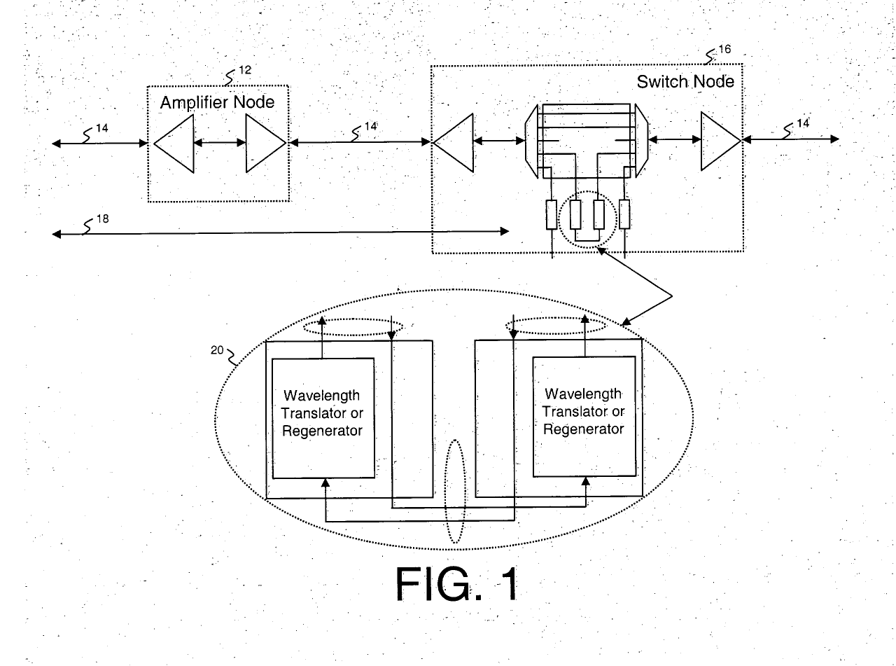

FIG. 1 illustrates an exemplary optical transport network segment in an optical transport network. The optical transport network segment is generally comprised of optical amplifier nodes and network-switching nodes as is well know in the art. Amplifier nodes are interposed between switching nodes when the distance between the switching nodes is such that optical regeneration is otherwise required in order to establish optical signal continuity and adequate transmission performance.

An amplifier node 12 is adapted to terminate two bidirectional optical transmission sections paths 14 as shown in FIG. 1. Each optical transmission section 14 carries one or more optical multiplex section signals and optical supervisory channels. An optical multiplex section link may be formed between two amplifier nodes and is supported by an optical transmission section path. At the amplifier node, the optical multiplex section signals are processed, without being terminated. Optical multiplex section signal processing typically consists of optical amplification and overhead processing, however dispersion compensation and gain equalization may also be performed. Once processed, they are adapted and combined, together with an optional optical supervisory signal, into an optical transmission section signal. The optical transmission section signal is then launched into the optical transport network over a fiber optic cable pair that enables bidirectional transmission.

FIG. 1 also illustrates an exemplary optical network-switching node 16 that supports switching of optical channels. Optical transmission sections 14 and optical multiplex sections 18 are terminated/originated at every network-switch node. An optical multiplex section path is formed by one or more serially concatenated optical multiplex section links and fixed optical multiplex section connections.

The network-switching node 16 is adapted to receive one or more bidirectional optical transmission sections. The optical transmission sections are in turn connected to a plurality of termination points that are operable to terminate the optical transmission section and separate it into one or more Optical multiplex sections. The optical multiplex sections may be directed to one or more switch fabrics or may be manually routed to static demultiplexing equipment.

The static demultiplexing equipment is operable to terminate an optical multiplex Section and separate it into a plurality of wavelength signals or effectively, a plurality of optical channels. The static demultiplexing equipment may alternately be operable to terminate an optical multiplex section and separate it into a plurality of wavelength groups or effectively, a plurality of optical channel groups. The inputs and outputs of the demultiplexing equipment will be compatible with a range of wavelength frequencies and the spectral bandwidth of each wavelength. The optical multiplex section optical overhead is terminated or generated when the optical multiplex section is terminated or generated. The optical channels are effectively routed in the optical domain from one optical multiplex section to any other optical multiplex signal or add/drop port using fiber connections as is well known in the art. This type of optical channel cross-connection is referred to as static or manual optical channel connection.

The switch is operable to terminate an optical multiplex section and separate it into a plurality of wavelength signals or effectively, a plurality of optical channels. The optical multiplex section input and output ports of the switch will be compatible with a range of Wavelength frequencies and the spectral bandwidth of each wavelength. The switch fabric is operable to route an optical channel, in the optical domain, from one optical multiplex section port to any other optical multiplex section port or add/drop port as is well known in the art. The routing Of the optical channel is flexible and based on a cross-connection specified by the network management or control plane system. The optical multiplex section optical overhead is terminated or generated when the optical multiplex section is terminated or generated.

The add/drop ports of the switch may be connected to transponders, wavelength translators, wavelength regenerators, channel pass-through or special purpose test equipment. In addition, in an agile optical network the transponders, wavelength translators and wavelength regenerators are capable of terminating/generating a wavelength over a range of frequencies. These devices are capable of terminating and generating optical overhead information that is transported in an associated and non-associated manner as is well known in the art. The optical overhead may be used to monitor the configuration, connectivity, performance and state of the optical channel link, path or lightpath.

The wavelength translator and regenerator are used for wavelength frequency translation and also for correcting transmission impairments within the optical transport network. They terminate an optical channel and its optical overhead at one frequency, process the lightpath in the electrical domain and then generate a new optical channel at the same frequency, in the case of the regenerator, or at a different frequency in the case of the translator. Optical overhead is added to the optical channel to enable its management and transmission through the optical transport network. The wavelength translator or regenerator is connected to the switch add/drop port. The optical channel is routed and multiplexed by the switch to any optical multiplex section signal port. FIG. 1 illustrates a pair of exemplary wavelength translators 20 that each terminate and generate an optical channel path in the add direction while not terminating it the drop direction. Note that the wavelength translator or regenerator transmitter and receiver may optionally be connected via an electrical switch fabric.

A transponder provides an optical transport network access point for client signals. The client optical signal is terminated and processed in the electrical domain. The transponder may be connected to one client signal and adapts it into a lightpath and subsequently adapts the ligthpath into an optical channel. The transponder may also be connected to multiple client signals that are aggregated and adapted into a ligthpath and subsequently adapts the ligthpath into an optical channel. Optical overhead is added to the optical channel and lightpath to enable their management and transmission through the optical transport network. The transponder converts the optical channel into a wavelength having a specified frequency, transmission rate, modulation scheme, reach and optical overhead. The transponder may also be disconnected from the client signal when it is unassigned or during commissioning or test periods. The optical channel is add/dropped, routed and multiplexed by the switch to any optical multiplex section signal port as is well known in the art.

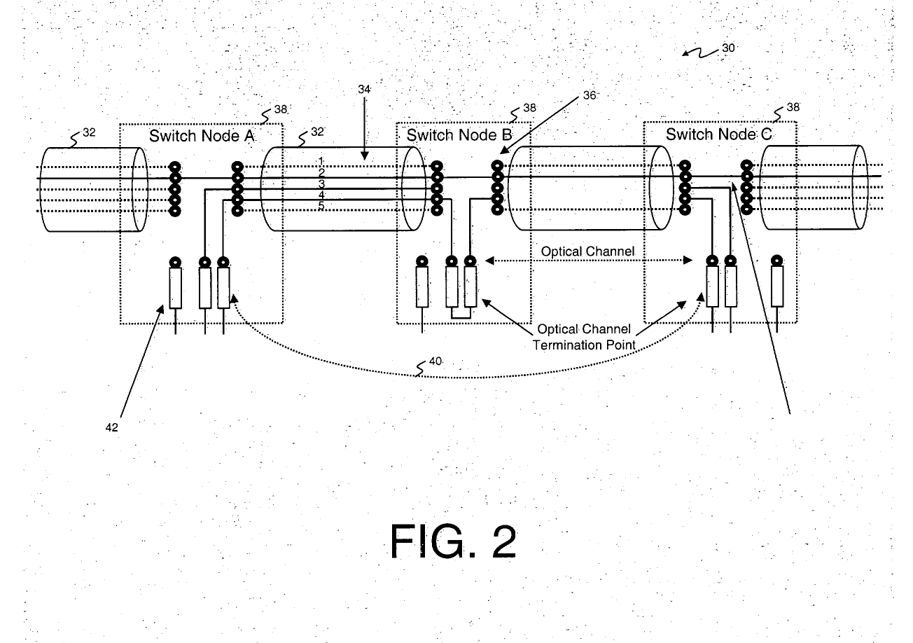

FIG. 2 illustrates an exemplary optical network segment 30 that further identifies the managed transport entities. Each optical multiplex section 32 contains numerous optical channel links 34 that are terminated at connection points 36 within the network-switching nodes 38. A network-switching node 38 provides a configurable switch fabric that enables cross-connections to be formed between the optical channel connection points or between the optical channel connection point and the optical channel path termination point in the transponder, wavelength translators and regenerators. An optical channel path is created when a network connection is made between a transponder pair, or between a transponder and a wavelength translator or regenerator, or between wavelength translators or regenerators. A lightpath designated at 40 is created when a network connection is made between a transponder pair. The network-switching nodes 38 may contain pre-deployed transponders 42 that are not assigned to a client and/or to an optical channel link. The transponders may be cross-connected to any unassigned optical channel connection point; however some restrictions may apply due to architectural limitations (i.e., blocking switch fabric implementation). The network-switching nodes 38 may also contain special test equipment that is capable of generating/monitoring/terminating valid wavelengths, optical channels and lightpaths like a transponder.

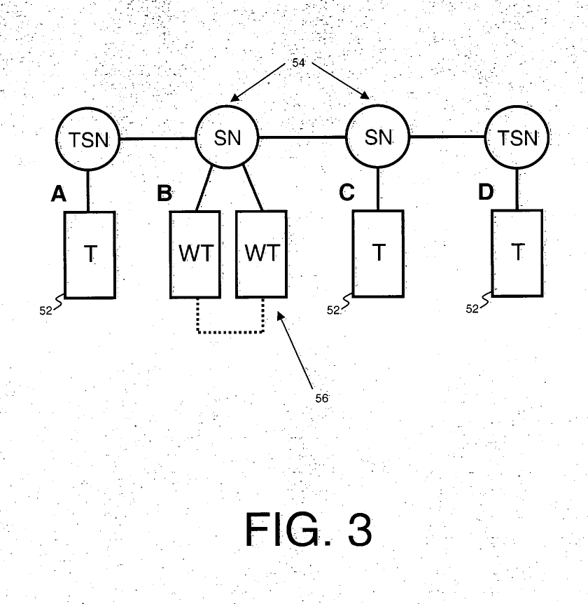

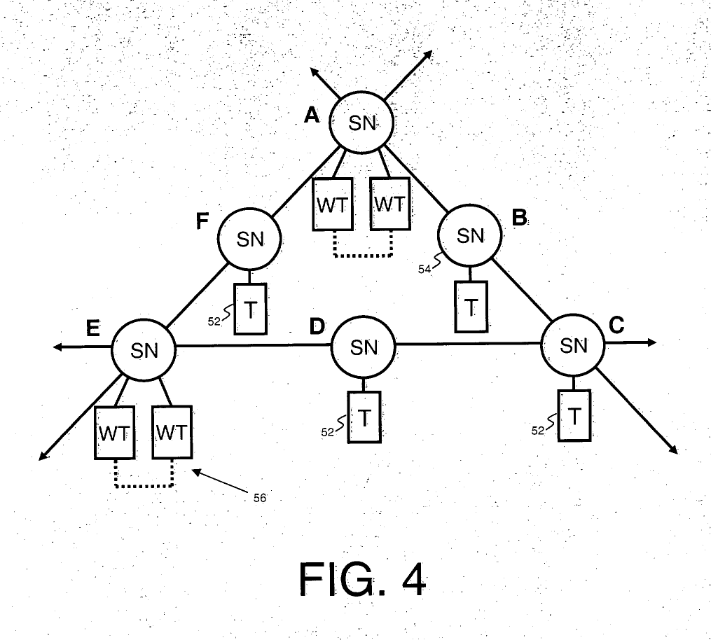

FIGS. 3 and 4 illustrate exemplary agile linear and mesh optical network segments, respectively, where the transponders 52 may be inter-connected over a range of wavelength frequencies and over a number of diverse routes. The network-switching nodes 54 are used to route the optical channel, in the optical domain, through the network. Wavelength translation and regeneration may be dynamically switched at the midpoints to support lightpath routing and to meet a specified quality of service. In addition, transponders, wavelength translators, wavelength regenerators or special purpose test receivers may be deployed at any switching node as shown at 56 and be connected to the wavelength, optical channel or lightpath in such a way as to perform non-intrusive monitoring of the signal passing through the node.

An optical channel link may be assigned and lit when it forms part of an optical channel path. An optical channel link may be assigned and unlit when a shared bandwidth service is provided such as for optical layer protection, restoration, or for switched lightpath services. In such a scenario, an optical channel link is allocated to and shared amongst multiple optical channel paths at different times with the arbitration being performed by a network management or control plane system. The optical channel link will be unassigned and unlit when it is not part of an optical channel path. Optical channels will also be lit or unlit depending on its service state as well as that of the terminating equipment, e.g., transponders. Optical channels and terminating equipment will typically be unlit when they are administratively and/or operationally out-of-service.

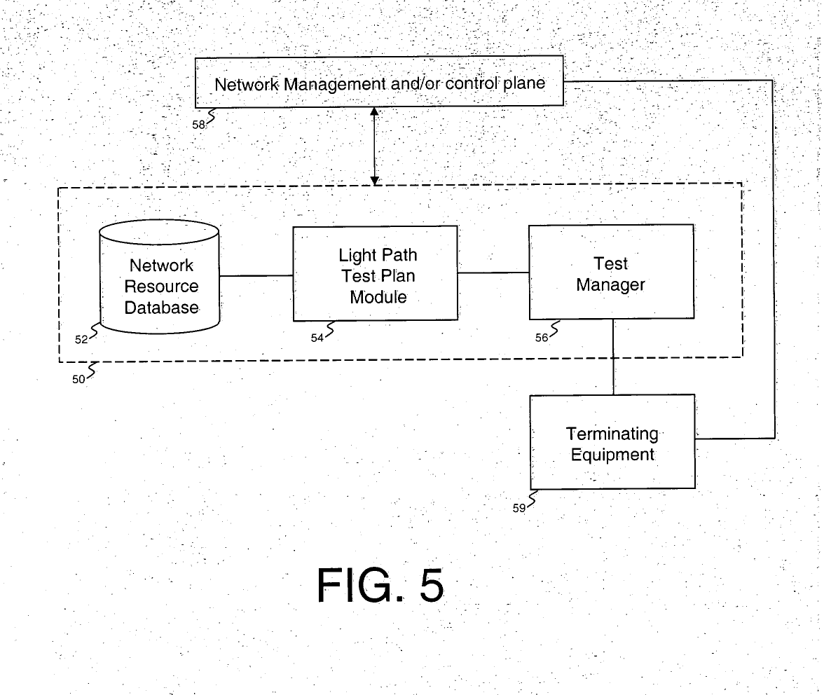

In accordance with the present invention, a lightpath exerciser 50 for testing lightpaths in an optical transport network is depicted in FIG. 5. The light path exerciser 50 is generally comprised of a network resource data store 52, a lightpath determination module 54, and a test manager 56. It is to be understood that only the primary components and functions of the lightpath exerciser 50 are discussed below, but that other software-implemented components or functions may be needed to control and manage the overall operation of the lightpath exerciser.

The network resource data store 52 includes network topology data and network configuration data for the optical transport network. In particular, the network resource data store 52 will contain a network resource map and database of all the optical channel links, optical channel paths, lightpaths including all the associated terminating equipment. The network resource database may also contain management information, including but not limited to, assignment, routing, performance, configuration, utilization, state and quality of service parameters for each entity as appropriate to enable managing an optical network. Such network topology and network configuration data is typically maintained and managed by the network management and/or control plane system as is well known in the art.

In one exemplary embodiment, the data for the network resource data store 52 may be a copy of data maintained by the network management and/or control plane system 58. When a local copy of the network resource database resides in the lightpath exerciser 50, a means to update the information based on any changes to the network will be provided by the lightpath exerciser. Synchronizing the exerciser network resource database to the network resource database of the network management and/or control plane system will avoid any unnecessary path set up request denials due to resource utilization and will also maximize the network test coverage.

The lightpath determination module 54 is adapted to access the network resource data store 52. Given the network topology data and the network configuration data, the lightpath determination module 54 is able to determine potential test lightpaths, including one or more unlit lightpaths in the optical transport network. Specifically, the lightpath determination module 54 provides the capability to identify resources to test using an explicit selection process or sequence, or using a random or pseudo-random selection process. The selection of optical channel links, optical channel paths and lightpaths for test will be based on the pool of available transponders, wavelength translators, regenerators or special test equipment, i.e., unassigned terminating equipment. For example, the lightpath determination module 54 will scan the network resource database and flag the terminating equipment that may be used for performing tests. The lightpath determination module 54 will then scan the network resource database and flag the optical channel links that may be used for the tests. The lightpath determination module 54 uses the list of terminating equipment and optical channel links together with a routing algorithm to determine all of the optical channel paths and lightpaths that can be established and tested including the routing constraints. Optical channel links, paths, lightpaths or equipment that are out of service due to operational failures or administrative restrictions will not be tested unless explicitly specified to the lightpath exerciser 50.

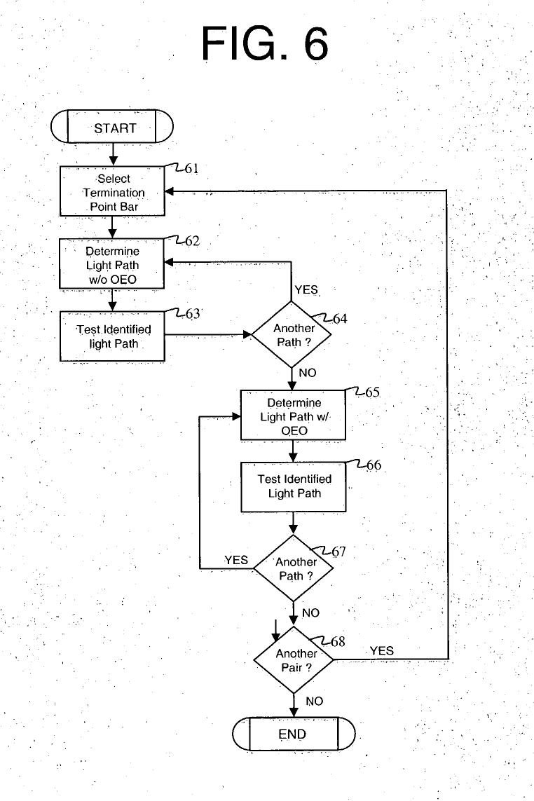

An exemplary method for determining potential test lightpaths is further described in relation to FIG. 6. Potential test lightpaths are determined by first selecting termination point pairs at step 61 within the optical transport network. In one exemplary embodiment, combinations of termination point pairs are derived from all of the unassigned termination points residing in the network, where each termination point may be connected with an unassigned terminating equipment. However, it is also envisioned that an operator may be able to restrict the scope of testing as further described below.

Since numerous unassigned lightpaths may exist between a given termination point pair, possible lightpaths are determined in the following manner. A first potential test lightpath is determined at step 62. For instance, the first potential test lightpath is designated as the shortest path (i.e., physical distance) between the termination points, where the lightpath does not require an optical to electrical signal conversion. At step 63, the first potential test lightpath is then set up and tested as further described below. After the first potential test lightpath has been tested, the next shortest lightpath not requiring an optical to electrical signal conversion is identified, set up, and tested. This process is repeated until each of the possible unassigned lightpaths which do not require an optical to electrical signal conversion are identified, set up and tested as shown at step 64. It is readily understood that other metrics may be used to select potential lightpaths. For instance, potential lightpaths may be based on determined based on the cost associated with the path.

Next, potential test lightpaths are identified that include at least one optical to electrical signal conversion. A potential test lightpath having the shortest path with at least such conversation is determined at step 65. The identified lightpath is then set up and tested at step 66 as further described below. Again, this process is repeated until each of the possible unassigned lightpaths which requires one or more optical to electrical signal conversions are identified, set up and tested as shown at step 67. In this way, all of the unassigned lightpaths that exist between a given termination point pair are tested.

Lastly, potential test lightpaths are generated for each of the termination point pairs as shown at 68. As a result, potential test lightpaths are determined for all combinations of termination point pairs. Rather than immediately test each identified lightpath as discussed above, it is also envisioned that this algorithm may be used to generate a list of potential test lightpaths for subsequent processing by the lightpath exerciser.

Depending on the availability of terminating equipment and optical channel links, some paths and equipment may not be tested. In addition, the capability to prioritize and/or exclude selected transport entities and/or terminating equipment which are to be tested may be supported by the lightpath exerciser. The lightpath exerciser may provide the capability to sectionalize the testing to subnetworks as well as support testing optical channel paths and lightpaths across multiple subnetworks at the operator's discretion. The lightpath exerciser may be capable of testing one or more optical channel links, optical channel paths and lightpaths simultaneously in one or more subnetworks. For example, the test subnetwork may consist of only one optical multiplex section span and all of the unlit optical channel links and terminating equipment along it. Untested network resources will be identified by the lightpath exerciser and flagged in the network resource database.

Another more general non-sub-networked view of sectionalization is that if lightpaths with certain channel links and channel paths work, but others with some of the same channel links and channel paths don't, then this implies one or more of the different channel links or channel paths may be at fault. Thus, thru on-going light path testing with different wavelengths, a set of implied, perhaps wavelength specific, faulty channel links or channel paths is identifiable for follow-up action.

The test manager 56 provides the capability to perform test operations in relation to one or more of the identified potential test lightpaths. Test operations are generally intended to detect transmission equipment problems such as, but not limited to, optical line amplifier degradations, switch fabric degradations, optical monitoring equipment degradations, etc., which may Otherwise not be detected until one or more unlit optical channels are turned up, i.e., lit.

The test manager 56 may provide the capability to perform test operations continuously, on demand, or based on schedule. Scheduled tests may be performed on a one time basis, periodic basis or a-periodic basis. The duration of a test may be programmable and any test may be suspended, resumed, terminated or pre-empted at any time to support a new or switched service request. The test data for a pre-empted test may be stored in the network resource database or discarded if inconclusive at the discretion of the operator. The test manager 56 may provide the history of test start and stop times. In addition, the capability to enable or disable tests may also be provided by the test manager 56.

When performing a test operation, the test manager 56 will typically not interfere with the normal operation of the network. For instance, a test operation will not interfere with an assigned optical channel or lightpath links and paths unless the testing is coordinated with the network management or control plane. However, when an optical channel or lightpath link or path is not being used by the client, they may be included in the tests performed by the lightpath exerciser. The exerciser will abort the test and release the links, path and equipment when the network management system or control plane informs it that the client signal requires access to the optical channel or lightpath links or paths. Thus, the testing of assigned optical channel or lightpath links or paths may require that the test manager 56 coordinates with the client layer equipment, management system or control plane so that it does not interfere with the client layer service.

In a preferred embodiment, only the network management or control plane system will be responsible for actually establishing, rearranging and tearing down test paths. The optical channel paths and lightpaths to be tested, together with the routing constraints, will be provided by the test manager 56 to the network management system or control plane based on the test profile, i.e., on demand, scheduled, continuous, etc. The network management system or control plane will use the information provided by the test manager together with a routing and signaling algorithm, such as generalized MPLS or other similar protocol, as is well known in the art, to establish the test paths.

The network management or control plane sub-system will signal all of the cross-connections by communicating with the switching nodes via an optical supervisory channel or external data communications network or both. Based on the path setup request from the test manager 56, the routing and signaling protocol establishes the test paths by making the appropriate cross-connections in the network-switching nodes. At mid-points of the test path, the associated optical channel connection points are cross-connected. At end-points of the test path, the associated optical channel connection point is cross-connected to the selected terminating equipment. Once all the cross-connections are completed, the test path is formed.

When a client signal is not connected to a pre-deployed transponder or When the client signal is connected but not using the optical channel path or lightpath, a client signal surrogate payload will have to be inserted by the transponders into the lightpath in order to generate a valid wavelength signal. Similarly, special purpose test equipment will also have to be capable of generating client surrogate signals for the same reason. Wavelength translators and regenerators also require the capability to inject a surrogate lightpath signal into an optical channel as there may not be any input signal into the translator or regenerator. Therefore, the test manager 56 must be capable of activating and deactivating the insertion of a client or lightpath surrogate signals at the terminating equipment. When a client signal is connected to a pre-deployed transponder but is not using the optical channel path or lightpath, the activation and deactivation of the client surrogate signal must be coordinated with the client layer equipment, management system or control plane so that it does not interfere with the client layer service. The test manager 56 should allow the selection of a surrogate payload type, for each path under test, which may be either a fixed pattern, or a random pattern or one of many various pseudo-random patterns.

Thus, the test manager 56 also provides the capability to turn up the optical channel path. Depending on the equipment, fiber plant and signal reach characteristics, the turn up procedure involves turning on the transmitter laser, adjusting the optical transmit and/or receive power and optionally calibrating the optical transmitters and receivers on the terminating equipment. The calibration process may involve adjusting one or more parameters such as, but not limited to; dispersion compensation setting, amplitude and phase decision threshold settings, as well as optical power and gain settings to obtain the optimal signal quality. The calibration settings for each optical channel path and terminating equipment may be stored in the network resource database and reused in the future to recalibrate the optical channel path terminating equipment. Wavelengths will be lit and unlit during the turn up and turn down processes in such a manner so as to not interfere with the client traffic bearing wavelengths.

Once an optical channel path and lightpath is turned up, the test manager 56 and/or network management and/or control plane system will collect and store performance and status test information in the network resource database for each monitored entity. The collection of the test data may be performed at both ends of the optical channel path or lightpath or it may be performed at only one end point. For singled ended monitoring, the amount of data collected will be limited to the local test data and any remote error indications and/or remote defect indications can be returned from the far-end via the optical overhead information as is well known in the art. The test data may be obtained by direct signal measurements or be derived from the information provided in the optical overhead. The test data may include (but is not be limited to) optical channel path, lightpath and client surrogate bit error rate (BER), wavelength optical signal to noise ratio, Q or Q margin, forward error correction statistics, signal fail status, signal degrade status, connection status, optical spectrum information, laser bias current and temperature, transmit and receive optical signal power levels as well as path trace information as is well known in the art.

The test results and calibration data obtained from the lightpath exerciser 50 are then stored in the network resource database. This information may then be used by the switching nodes, network management system and/or control plane when making routing and switching decisions or turning up new optical channel paths and lightpaths.

The test manager 56 or network management system or control plane system may also alert the operator if any failures occur during the test or calibration processes. The test manager 56 may provide the capability to configure threshold values for any monitored parameter and alert the operator when any thresholds are crossed. The operator may be notified when a failure or degraded condition clears. Alarms and alerts generated on test paths should be distinguished where possible from those that are actually providing service to client signals.

The test manager 56 or network management system may provide standards based performance monitoring metrics such as, but not limited to, coding violation count, block error count, errored seconds, severely errored seconds, unavailable seconds and defect seconds as is well known in the art. The performance and test data may be stored in a configurable number of history registers with configurable collection intervals. The capability to retrieve the performance data on demand or on a scheduled basis may also be provided.

The lightpath exerciser may be capable of non-intrusively connecting and monitoring wavelengths, channels and lightpaths at switching nodes to perform more extensive testing and sectionalization of wavelength, channel and lightpath degradations and failures. For example, if a degraded signal condition is detected at the path terminating point, the signal may be tapped at intermediate points along the path and its performance measured without affecting the end-to-end transmission. Tap based testing is established using the same wavelength turn up process described above except that the transmitter is turned off.

The lightpath exerciser may provide a summary measure of relative quality or figure of merit associated with the link, lightpath or equipment to the network management or control plane system for demand length routing, protection or restoration decisions. Based on the quality of the links, lightpaths and equipment, the lightpath exerciser may also provide a prioritized list recommending preventative maintenance actions.

Lastly, optical channels may be looped back in the optical domain at a network-switching node onto the same optical multiplex section or add/drop pFort. Optical multiplex section signals may be looped back in the optical domain at amplifier and network-switching nodes. Lightpaths may be looped back in the electrical domain at terminal equipment, i.e., transponders and wavelength translators. The lightpath exerciser may be capable of establishing loopbacks at switching nodes, amplifier nodes, transponders, Wavelength translators, and wavelength regenerators to perform more extensive testing and sectionalization of wavelength, channel and lightpath degradations and failures. For example, the output of a transponder may be looped back through the switch node to its input to test the transmitter and receiver wavelength frequency range.

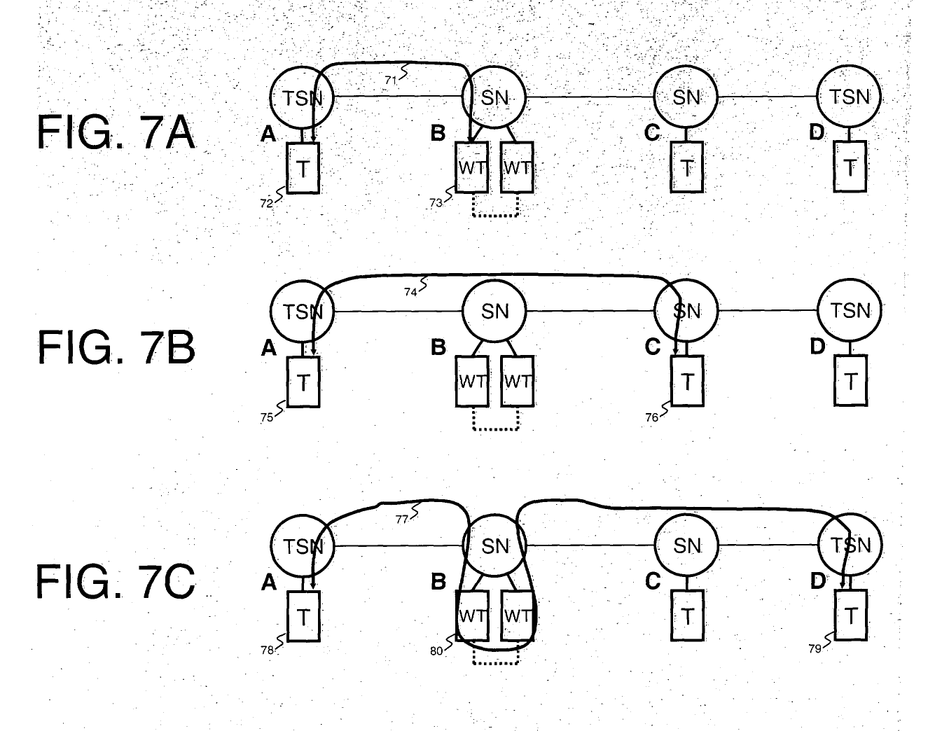

FIGS. 7A, 7B and 7C are diagrams depicting an exemplary linear network under test in accordance with the present invention. In FIG. 7A, a lightpath designated at 71 has been established between a transponder 72 in node A and a wavelength translator 73 in node B. The lightpath 72 is formed using one optical channel path. The optical channel path is formed using one optical channel link and an optical channel cross-connection at each end point, A and B. In FIG. 7B, a lightpath designated at 74 has been established between a transponder 75 in node A and a transponder 76 in node C. The lightpath 74is formed using one optical channel path. The optical channel path is formed using two optical channel links, an optical channel cross-connection in node B and an optical channel cross-connection at each end point, A and C. In FIG. 7C, a lightpath designated at 77 has been established between a transponder 78 in node A and a transponder 79 in node D. The lightpath 77 is formed using two optical channel paths and a lightpath connection between the two lightpath links at node B. One optical channel path is originated at node A and is terminated at the wavelength translator 80 at node B. The second optical channel path is originated at node B and terminated at the wavelength translator at node D. The optical channel path between nodes A and B is formed using one optical channel link and an optical channel cross-connection at each end point, A and B. The optical channel path between nodes B and D is formed using two optical channel links, an optical channel cross-connection in node C and an optical channel cross-connection at each end point, B and D.

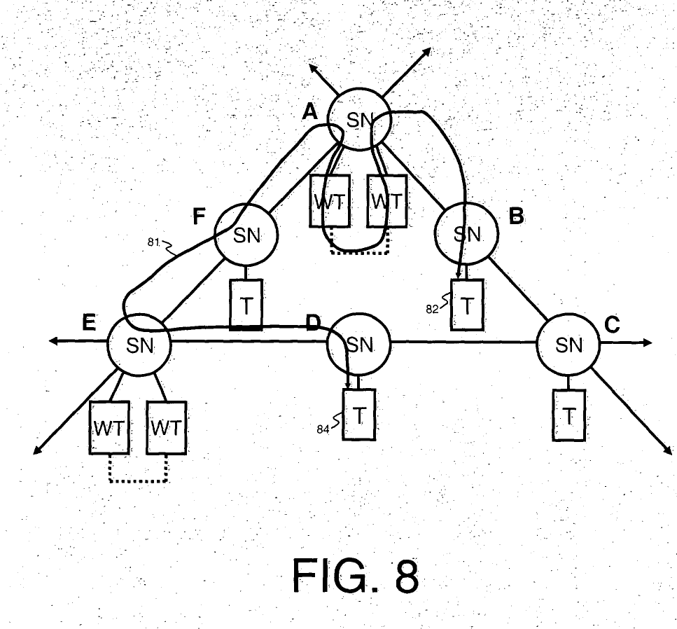

FIG. 8 is a diagram that depicts an exemplary mesh network under test in accordance with the present invention. A lightpath designated at 81 has been established between a transponder 82 in node B and a transponder 84 in node D. The lightpath 81 is formed using two optical channel paths and a fixed lightpath connection between the two lightpath links at node A. One optical channel path is originated at node B and is terminated at the wavelength translators at node A. The second optical channel path is originated at node A and terminated at the wavelength translator at node D. The optical channel path between nodes A and B is formed using one optical channel link and an optical channel cross-connection at each end point, A and B. The optical channel path between nodes D and A is formed using three optical channel links, an optical channel cross-connection in nodes E and F, and an optical channel cross-connection at each end point, D and A.

While the invention has been described in its presently preferred form, it will be understood that the invention is capable of modification without departing from the spirit of the invention as set forth in the appended claims.

What is claimed is:

1. A lightpath exerciser for testing unlit lightpaths in an optical transport network having a plurality of lightpaths, comprising:
a network resource data store for storing network topology data and network configuration data for the optical transport network, where the network configuration data includes assigned lightpath data for the optical transport network;
a lightpath determination module adapted to access the network resource data store and operable to determine potential test lightpaths based on the network topology data and the network configuration data, Where at least one potential test lightpath is an unlit lightpath in the optical transport network; and
a test manager connected to the lightpath determination module and operable to initiate a test operation in relation to the at least one potential test lightpath.

2. The lightpath exerciser of claim 1 wherein the network configuration data includes unassigned terminating equipment residing in the optical transport network, where the unassigned terminating equipment is operable to transmit an optical signal through the at least one potential test lightpath.

3. The lightpath exerciser of claim 2 wherein the unassigned terminating equipment is selected from the group consisting of transponders, wavelength translators, and wavelength regenerators.

4. The lightpath exerciser of claim 1 wherein the at least one potential test lightpath is in part defined by two optical multiplex sections connected by a network element.

5. The lightpath exerciser of claim 1 wherein the at least one potential test lightpath is in part defined as an unlit optical channel path in an optical multiplex section, where the optical multiplex section supports a plurality of optical channel paths and at least one previously assigned optical channel path.

6. The lightpath exerciser of claim 1 wherein the test manager is in data communication with at least one unassigned terminating equipment residing in the optical transport network, where the unassigned terminating equipment is operable to transmit an optical signal through the at least one potential test lightpath.

7. The lightpath exerciser of claim 1 wherein the lightpath determination module is further operable to formulate a path setup request which correlates to the at least one potential test lightpath and communicate the path setup request to a network management subsystem associated with the optical transport network.

8. The lightpath exerciser of claim 1 wherein the network management subsystem is operable to configure the at least one potential test lightpath based on the path setup request.

9. The lightpath exerciser of claim 1

10. A software-implemented method for testing unlit lightpaths in an optical transport network having a plurality of lightpaths, comprising:
determining network topology data for the optical transport network,
determining network configuration data for the optical transport network, where the network configuration data includes assigned lightpaths;
determining potential test lightpaths based on the network topology data and the network configuration data, where at least one potential test lightpath is an unlit lightpath in the optical transport network; and
initiating a test operation in relation to the at least one potential test lightpath, where the at least one potential test lightpath is in part defined by two optical multiplex sections connected by a network element.

11. The method of claim 10 wherein the step of determining network configuration data for the optical transport network further comprises identifying unassigned terminating equipment residing in the optical transport network.

12. The method of claim 11 wherein the step of determining potential test lightpaths further comprises identifying unassigned lightpaths having unassigned terminating equipment at each end of the unassigned lightpath.

13. The method of claim 11 wherein the unassigned terminating equipment is selected from the group consisting of transponders, wavelength translators, and wavelength regenerators.

14. The method of claim 10 wherein the step of initiating a testing operation further comprises transmitting a surrogate optical signal over the at least one potential test path.

15. The method of claim 10 Wherein the step of initiating a testing operation further comprises formulating a path setup request which correlates to the at least one potential test lightpath and communicating the path setup request to a network management subsystem associated with the optical transport network, where the network management subsystem is operable to configure the at least one potential test lightpath.

16. The method of claim 10 further comprises collecting test data resulting from the test operation and configuring the optical transport network based on the collected test data.

17. A method for determining potential test lightpaths in an optical transport network, comprising:
accessing network topology data for the optical transport network, where the network topology data defines a plurality of lightpaths in the optical transport network;
accessing network configuration data for the optical transport network, where the network configuration data identifies assigned lightpaths and unassigned terminating equipment in the optical transport network; and
identifying unassigned lightpaths having unassigned terminating equipment at each end of the unassigned lightpath based on the network configuration data and the network topology data.

18. The method of claim 17 wherein the step of identifying unassigned lightpaths further comprises selecting an unassigned terminating equipment pair; and determining at least one unassigned lightpath between the unassigned terminating equipment pair.

19. The method of claim 17 wherein the step of identifying unassigned lightpaths further comprises:
(a) selecting an unassigned terminating equipment pair;
(b) determining each unassigned lightpath between the unassigned terminating equipment pair that does not require an optical to electrical signal conversion; and
(c) determining each unassigned lightpath between the unassigned terminating equipment pair that requires at least one optical to electrical signal conversion.

20. The method of claim 19 further comprises repeating steps (a)-(c) for each unassigned terminating equipment pair residing in the optical transport network.
